(19) United States
(12) Patent Application Publication
(10) Pub. No.: US 2010/0283587 A1
(43) Pub. Date: Nov. 11, 2010

(54) DEVICE FOR TESTING OF A POWERLINE COMMUNICATIONS AUDIO SYSTEM

(76) Inventor: Fredrick W. KUKULIES, Cincinnati, OH (US)

Correspondence Address: Hasse & Nesbitt LLC, 8837 Chapel Square Drive, Suite C, CINCINNATI, OH, 45249, US

(21) Appl. No.: 12/723,430

(22) Filed: Mar. 12, 2010

Related U.S. Application Data
(60) Provisional application No. 61/159,771, filed on Mar. 12, 2009.

(51) Int. Cl. G05B 11/01

(52) U.S. Cl. 340/310.11

(57) ABSTRACT

A system and devices for testing and qualifying the quality, capacity and integrity of a new or existing mains power wiring system to transmit powerline communications (PLC) audio and control signals, including a hub testing device that emulates a PLC interface device of a PLC audio transmission source, and a zone testing device that emulates a zone audio amplifier module, including a plug for insertion of the devices into an outlet of an AC mains wiring system. The devices are used in a method for testing and qualifying a new or existing mains power wiring system to transmit powerline communications (PLC) audio and control signals, having the steps of selecting a hub outlet and plugging a hub testing device into the hub outlet, initiating a search for a zone testing device, selecting and plugging in a zone testing device into an test outlet in a target zone; initiating a test selected from a CQM test and a Streaming Analysis; and correlating the results of the test to determine if the selected hub outlet and the test outlet qualify to transmit powerline communications (PLC) audio and control signals in the target zone.

### CROSS-REFERENCE TO RELATED APPLICATIONS

The present application claims the benefit of US Provisional Application 61/159,771, filed Mar. 12, 2009, the disclosure of which is incorporated herein by reference.

### BACKGROUND OF THE INVENTION

Broadcasting audio or music, such as background music, within a facility is generally desirable to provide a relaxing or entertaining atmosphere or to enhance a desired theme or mood. In particular, buildings such as houses, hotels, restaurants, casinos, shopping malls, and other indoor or outdoor areas often are equipped with sound distribution systems to provide music and paging capability to different locations in or around the building or area.

New home and office construction installations typically run communication cables (typically CAT-5) and standard speaker wire (typically 16, 14, or 12 gauge) between a centrally-located audio transmission source and the various separate rooms and areas of the building. The cable routing is typically done through the wall, floor and ceiling framework before the drywall, paneling and flooring are installed. Depending upon the number of rooms and areas, and number of speakers in a room or area, the size and weight of the bundle of wires can be substantial, affecting the routing of cabling and wires through floor joists, walls and flooring.

There are even greater challenges to installing multi-room audio in existing homes, where access for routing the cables and wires is very limited. Many installers of multi-room audio systems limit installations to new builds only, where they have easy access to open walls.

A power line communications system operates by impressing a modulated carrier signal on the wiring system. Different types of powerline communications use different frequency bands, depending on the signal transmission characteristics of the power wiring used. Since the power wiring system was originally intended for transmission of AC power, the power wire circuits have only a limited ability to carry higher frequencies. The propagation problem is a limiting factor for each type of power line communications.

Data rates over a power line communication system vary widely. Low-frequency (about 100-200 kHz) carriers impressed on high-voltage transmission lines may carry one or two analog voice circuits, or telemetry and control circuits with an equivalent data rate of a few hundred bits per second; however, these circuits may be many miles (kilometres) long. Higher data rates generally imply shorter ranges; a local area network operating at millions of bits per second may only cover one floor of an office building, but eliminates installation of dedicated network cabling.

Power line communications can also be used to interconnect home computers, peripherals or other networked consumer peripherals, although there is not yet a universal standard for this type of application. Standards for power line home networking have been developed by a number of different companies within the framework of the HomePlug Powerline Alliance and the Universal Powerline Association (UPA). Many companies and standard bodies are participating in the developing IEEE P1901 standard including HomePlug Powerline Alliance, UPA, CEPCA (Japan) and OPERA (European Union).

Systems, components and methods for testing PLC equipment, network conditions and protocol performance at different points in a PLC network are described in US Publ 2008-0055067, U.S. Pat. No. 6,317,031, U.S. Pat. No. 6,141,634, U.S. Pat. No. 6,466,029, the disclosures of which are incorporated by reference in their entireties.

Recently, PLC audio devices have been developed that can plug into, or retrofitted and integrated into, a PLC-powered outlet and can output digital and/or analog signals through audio signal outputs to either built-in or separate remote speakers in the room, as described in US Patent Publication 2007-0022197, the disclosure of which is incorporated by reference in its entirety. These devices can be accidently unplugged and unpowered from the powered wall outlets, interrupting the audio signal distribution to the speakers. Another type of PLC audio device is an on-wall or in-the-wall (PLC) audio device, including a within-the-wall power supply unit for receiving audio data in digital form transmitted through an AC mains power line and outputting the audio data in digital form, and an audio amplifier module for generating and amplifying audio signals based on the digital audio data, such as described in co-pending U.S. application Ser. No. 12/509147, entitled “Powerline Communications Audio Device and Zone Audio System”, the disclosure of which is incorporated herein by reference in its entirety.

The PLC audio devices typically have circuitry and controls for communicating with the audio transmission source, such as a PLC audio receiver with built-in speakers having PLC chips and two-way circuitry that controls the audio source input (AM/FM radio, CD, etc.), output volume, etc. An example of such a PLC audio receiver is the Avenue™ Zone Extender System, featuring an audio source (AZH-6 Hub) and one or more local zone devices (AZP-20 Point).

PLC audio devices and systems typically operate in real time, and do not typically rely upon buffering of the signals, as is typically done when transferring or streaming audio, video and data files over the internet. Consequently, PLC audio devices and systems function optimally and provide the best sound quality when the quality, capacity and integrity of the mains power lines in the facility into which the system is installed, or is to be installed, is sufficient to routinely and continuously transmit the PLC audio signals without interruption, deterioration of the signal, or the generation of static or other externally-sourced signals that can interfere with the quality of the audio signals. Such externally-sourced signals can result from the operation of other devices that are plugged or wired into the mains power lines.

The installation of PLC audio devices and systems into an existing facility, building or house typically involves the removal or remodeling of walls, ceiling or floors to install the physical devices and to route or connect to the mains power wiring. Typically, the PLC audio system is installed by accessing to existing mains power wires and power outlets that are selected by the installer or by the customer (building or home owner) based upon convenience or accessibility, or are selected simply randomly from any of the mains power wiring and outlets available in a room or area. AC power lines were never designed for use as a wide bandwidth data path and consequently no attention was paid to the use. AC power lines have varying amounts of capacitance, inductance, and resistance that attenuate a wide bandwidth signal. Additionally, electrical noise generated by motors, electronic devices, and some types of lights limit the ability of a high-bandwidth signal to reliably travel for one point to another. After an audio PLC system has been installed, it is possible that the configuration, quality, capacity and/or integrity of the mains power wiring or outlets are not sufficient for the PLC audio system to transmit, receive and produce high quality audio sound routinely and continuously without interruption or deterioration of the signal. Also, the operation of other devices that are plugged or wired into the mains power lines may later generate static or signals that can interfere with the quality of the PLC audio signals.

Therefore, there is a need for a device, tool and means for testing and qualifying the quality and integrity of new or existing mains power lines or system to conduct or carry audio and other signals from and between powerline communication (PLC) audio devices and PLC zone audio systems.

### SUMMARY OF THE INVENTION

The present invention provides a device for testing and qualifying, and a method for testing and qualifying, the quality, capacity and integrity of a new or existing mains power wiring system to transmit powerline communications (PLC) audio and control signals. The devices are also referred to as Site Survey Tools (SST) for surveying the capacity, quality and integrity of any mains powerline system to transmit PLC audio and control signals.

The testing device can include a hub or source testing device, and a zone or receiver testing device. A testing device can include all the features and functionality of each of the hub testing device and the zone testing device, with a selecting feature or element, including a switch selection, to designate the testing device either as the hub device or the zone device.

The invention provides system and devices for testing and qualifying the quality, capacity and integrity of a new or existing mains power wiring system to transmit powerline communications (PLC) audio and control signals, including: A) a hub testing device that emulates a PLC interface device of a PLC audio transmission source, including a means for plugging the device into an outlet of an AC mains wiring system, a means for generating a digital audio signal, a means for generating one or more testing signal selected from a control signal, a management signal, an interrogation signal, and a time data signal, a means for distributing an encoded digital audio data signal including the digital audio signal and the testing signal into and throughout the mains electrical line system to a zone testing device; and B) a zone testing device that emulates a zone audio amplifier module, including a means for plugging the device into an outlet of an AC mains wiring system, a means for separating the encoded digital audio data signal from the AC power current of the AC mains wiring system, a means for extracting audio data signals and control signals from the encoded digital audio data signals, a means for generating one or more of a result signal selected from a control signal, a management signal, an interrogation, and a time data signal, and a transmitter for transmitting the result signal through the AC mains wiring system to the hub testing device.

The hub testing device emulates the PLC interface device used in a conventional PLC audio system to distribute encoded digital audio data signals into and throughout the mains electrical line system. The testing device also transmits one or more of control, management, interrogation and time data signals through the mains system. A single hub testing device, or a plurality of hub testing devices, can be used in a testing and qualification of the PLC audio system.

The zone testing device emulates a zone audio amplifier module used in conventional PLC audio systems, by separating the encoded digital audio data signals from the AC power current, and extracting audio data signals and control signals from the encoded digital audio data signals. Samples of or a stream of the encoded digital audio data signals or extracted audio or control signals therefrom can be stored into memory. One or a plurality of zone testing devices can be plugged into the mains power lines network at one or a plurality of zones, including one or more separate rooms or floors, in the building or facility.

In a method of the invention, the hub testing device establishes communication (a “handshake”) with the zone testing device, and then using control and management modules, converses with the zone testing device to test, analyze and estimate the channel quality matrix (CQM) bandwidth of that outlet. The method uses the HomePlug® link characteristics to estimate the attainable bandwidth between the two points (the hub outlet and the zone outlet) in a building or house. The testing can be run in only a few seconds, and is the only testing that would need to be performed in most building or home installations.

The devices can also test, analyze, and estimate the data streaming capability of that outlet. This method sends blocks of data between the two testing outlets and measures the actual time required to deliver the data. This test is normally run for a few minutes during which time various external devices (appliances, computers, lights, power tools, etc.) attached to the AC mains wiring can be turned on or off, or unplugged, to locate potential or actual interference sources. Either or both of the devices can be configured to display the real-time quality and capacity, and the worst case quality and capacity, while the test is in progress, to allow the effect of the individual external devices to be assessed. This test is particularly useful when marginal communication quality has been detected or when an interference source needs to be tracked down.

In use, if a bad or questionable power outlet is tested and found, the installer can try another outlet in the room or zone where the zone testing device is plugged in, or in the room where the hub testing device is plugged in. Typically, the most common source of connection problems is excessive noise on the line. If the source of noise can be identified, there are remedies, typically the use of filters that can be installed on the zone amplifier to reduce or eliminate the noise.

Either or both testing devices are preferably compact so that it can be easily carried by hand, transported and stored. The testing device can be self-contained, so that additional wiring or controllers for connecting to an external display, user interface or input device, or computer or control device, are not required. The testing device is configured with a user interface, including a touch or key pad and a display screen, and can be powered off the power of the mains power lines) or self- or battery powered. The testing device is provided with a means for connecting or plugging the device into an outlet or other interface to the mains power lines. The plugging means can be a standard electric AC (male) plug that is integral to the device(s) and plugs the device directly to an electric outlet. The integral plug can be fixed in position on the device, or moveable or pivotable between an extended position for plugging into the outlet, and a retracted position. The plugging means can be a wired plug having a standard electric AC (male) plug on one end electrically connected by conducting wire to an electrically-conducting adaptor that plugs into the receiving port on the device.

The hub testing device includes sub-devices and circuitry for sending or simulating the sending of audio data and controller signals into the electrical AC mains power lines of the home or facility, by means substantially similar to those of PLC interface devices used in conventional PLC audio systems, to distribute the signal throughout the mains electrical line system.

The zone testing device includes sub-devices and circuitry for receiving of audio data and controller signals embedded in the AC current of the electrical AC mains power lines, separating the audio data and controller signals from the AC current, and testing or evaluating the quality, capacity and integrity of the mains power wiring system to transmit powerline communications (PLC) audio and control signals.

Either or both of the testing devices includes a software application or other means for correlating and evaluating the strength, quality and continuity of digital audio signals received across the PLC system.

Either the hub testing device or the zone testing device can include navigation buttons and control software for initiating, controlling and reporting the results of the audio testing. Either the hub testing device or the zone testing device can include a memory or data storage device, such as a flash memory drive, for storing and logging the testing operations, conditions, and data resulting therefrom. The memory or data storage device can store and output data in any selected format (for example, as comma delimited format), and can be connected directly or indirectly via wireless communications, to a computer without or with drivers for generating a display of the stored information.

The present invention also relates to a method for testing and qualifying the quality, capacity and integrity of a new or existing mains power wiring system to transmit powerline communications (PLC) audio and control signals, comprising the steps of: a) selecting a hub outlet proximate to the location of an audio transmission source; b) plugging a hub testing device into the hub outlet; c) initiating a search for a zone testing device; d) plugging in a zone testing device into an first test outlet in a target zone; e) optionally identifying the first test outlet via a user interface on the zone testing device; f) initiating a test selected from a CQM test and a Streaming Analysis; g) correlating the results of the test to determine if the selected hub outlet and the first test outlet qualify to transmit powerline communications (PLC) audio and control signals; and h) optionally downloading a test log.

### BRIEF DESCRIPTION OF THE DRAWINGS

FIG. 1 shows a front perspective view of a device for testing of a PLC audio system.

FIG. 2 shows a back perspective view of the testing device.

FIG. 3 shows the front elevation view of the testing device.

FIG. 4 shows the right side elevation view of the testing device.

FIG. 5 shows the top plan view of the testing device.

FIG. 6 shows the back elevation view of the testing device.

FIG. 7 shows the left side elevation view of the testing device.

FIG. 8 shows the bottom view of the testing device.

FIG. 9 shows a partial cut-away of the front panel of the testing device, showing the sub-devices and circuitry within the body.

FIG. 10 shows a front perspective view of a second embodiment of the testing device.

FIG. 11 shows a back perspective view of the testing device of FIG. 10.

FIG. 12 shows the front elevation view of the testing device of FIG. 10.

FIG. 13 shows the right side elevation view of the testing device of FIG. 10.

FIG. 14 shows the top plan view of the testing device of FIG. 10.

FIG. 15 shows the back elevation view of the testing device of FIG. 10.

FIG. 16 shows the left side elevation view of the testing device of FIG. 10.

FIG. 17 shows the bottom view of the testing device of FIG. 10.

FIG. 18 shows a front perspective view of a third embodiment of the testing device.

FIG. 19 shows a back perspective view of the testing device of FIG. 18.

FIG. 20 shows the front elevation view of the testing device of FIG. 18.

FIG. 21 shows the right side elevation view of the testing device of FIG. 18.

FIG. 22 shows the top plan view of the testing device of FIG. 18.

FIG. 23 shows the back elevation view of the testing device of FIG. 18.

FIG. 24 shows the left side elevation view of the testing device of FIG. 18.

FIG. 25 shows the bottom view of the testing device of FIG. 18.

FIG. 26 shows a front perspective view of a fourth embodiment of the testing device showing and integral electrical plug.

FIG. 27 shows a wired plug that can be used with the testing device of FIG. 2.

### DETAILED DESCRIPTION OF THE INVENTION

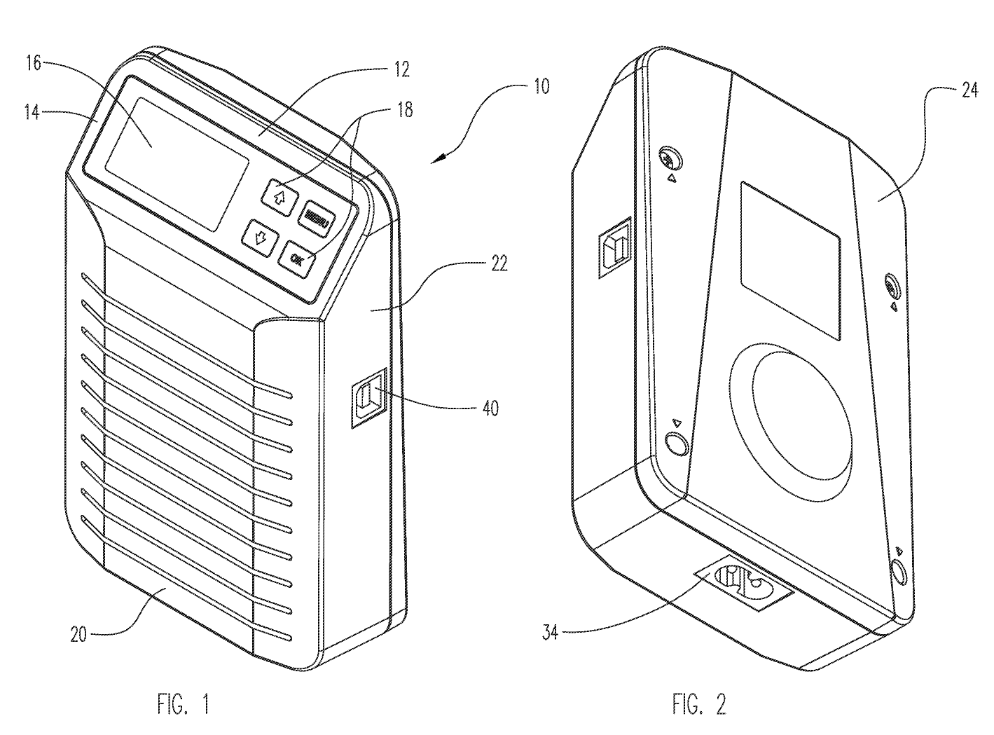

FIGS. 1 and 2 show a testing device. The hub testing device and the zone testing device have substantially the same external appearance and features. The testing device 10 includes a body 20, a user interface 12, and an optional external communication port 40, shown as an ethernet port. The body 20 includes a front cover plate 22 and a back plate 24, which are joined together and meet at their respective peripheries by well known means.

As shown in FIG. 9, within the body 20 is housed the sub-devices and circuitry, including an external port adapter 60, and PLC interface, memory, control module, and others. (element 62).

A hub testing device is provided that emulates a PLC interface device of a PLC audio transmission source, including a plug for insertion into an outlet of an AC mains wiring system, a means for generating a digital audio signal, a means for generating one or more testing signal selected from a control signal, a management signal, an interrogation signal, and a time data signal, a means for distributing an encoded digital audio data signal including the digital audio signal and the testing signal into and throughout the mains electrical line system to a zone testing device. The generating means and the distributing means that can be employed for generating digital audio and other digital signals and testing signals, and for distributing such digital signals are described in US Publ 2008-0055067, U.S. Pat. No. 6,317,031, U.S. Pat. No. 6,141,634, U.S. Pat. No. 6,466,029, US Publ 2007-0022197, US Publ 2006-0235552, the disclosures of which are incorporated by reference in their entireties.

A zone testing device is provided that emulates a zone audio amplifier module, including a plug for insertion into an outlet of an AC mains wiring system, a means for separating the encoded digital audio data signal from the AC power current of the AC mains wiring system, a means for extracting audio data signals and control signals from the encoded digital audio data signals, a means for generating one or more of a result signal selected from a control signal, a management signal, an interrogation, and a time data signal, and a transmitter for transmitting the result signal through the AC mains wiring system to the hub testing device. The separating means, extracting means, and result signal generating means that can be employed for separating and extracting digital audio and other digital signals and testing signals from the AC power current, and for generating the result signals, are described in US Publ 2008-0055067, U.S. Pat. No. 6,317,031, U.S. Pat. No. 6,141,634, U.S. Pat. No. 6,466,029, US Publ 2007-0022197, US Publ 2006-0235552, the disclosures of which are incorporated by reference in their entireties.

A user interface 12 is position on an angled upper panel 14 of the body, in order to allow the operator to see the display 16 and access the interface buttons 18 from the front or from above. The interface buttons typically include a menu button, one or more selection buttons, and a confirmation button. The display screen can include an Organic Light Emitting Diode (OLED) display, a Light Emitting Polymer (LEP) display, an Organic Electro Luminescence (OEL) display, and a Liquid Crystal Display (LCD).

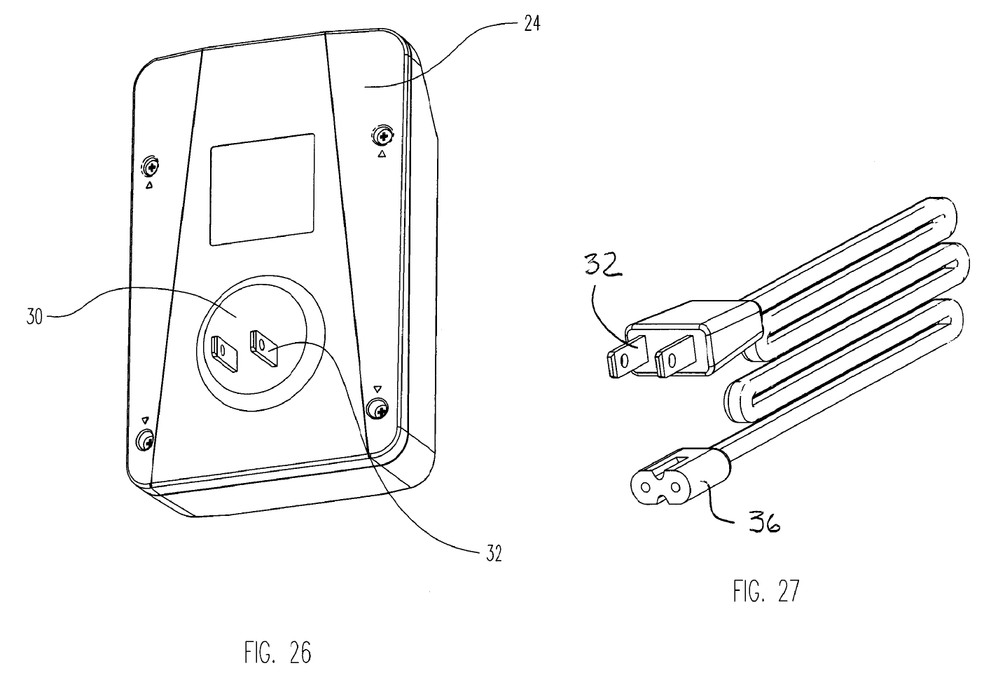

On the bottom of device as shown in FIG. 2 is an adaptor port 34 for receiving an adaptor plug 36, shown in FIG. 27, with electrical wiring extending to a male outlet plug for plugged the device into conventional (US style) AC outlets. In an alternative embodiment, the electrical plug can be integral with the device, as shown in FIG. 26, wherein the electrical plug 30 including the two prongs 32 is disposed on the back panel of the device. The integral plug assembly can also be made to recess or fold into the body 20, as is well known in the art. Other types and styles of plugs for power outlets used in other countries can be provided and are covered by the invention.

In a typical testing procedure using the testing devices, to qualify the suitability of an AC mains wiring outlet and system, an outlet proximate to the location is selected where the audio transmission source will be located, which includes one or more audio source units (radio, compact digital (CD) audio, Ipod, etc.) and a PLC interface with the AC mains wiring system. The hub testing device is plugged into that outlet. Typically a welcome message will be displayed and a menu screen will appear automatically or by pushing a Menu button. The menu will provide one or more operations that can be selected using the selection buttons. A “New Job Log File” is selected. The hub testing device initiates a search for zone testing devices that have been plugged into an outlet in the target zone, with the display showing a message, for example, “Searching for NV-SSTZONE”.

A zone testing device is then plugged into a desired outlet in a selected zone. To record which outlet and zone, a room or zone description can be selected from the menu, and an outlet identifier or number selected. The two devices will then automatically initiate a CQM test, with a progress bar shown on the display. Upon completion of the CQM test, the results will be displayed. If a problem is detected, a message will be displayed, and the operator prompted to repeat the test. If the CQM test shows adequate quality, then the operator will be prompted to initiate the Streaming Analysis (which may also be initiated automatically). The Menu and selection buttons can be used to select the duration of the Streaming Analysis. The test starts and a progress bar is shown in the display. The operator can optionally unplug devices, or can install isolation filters when interference sources have been found. Alternatively, the operator can test an alternative outlet in the zone by unplugging the test device and repeating in an alternative outlet.

The hub testing device is also be unplugged and plugged into another outlet in the hub area, and the zone testing repeated, either to establish a second hub outlet for use, or to determine if testing problems with the first hub outlet are alleviated with the selection of the second hub outlet.

After testing is finished, a computer can be plugged into the communications port (a USB port or Ethernet port) on the hub testing device to download the test log, if desired.

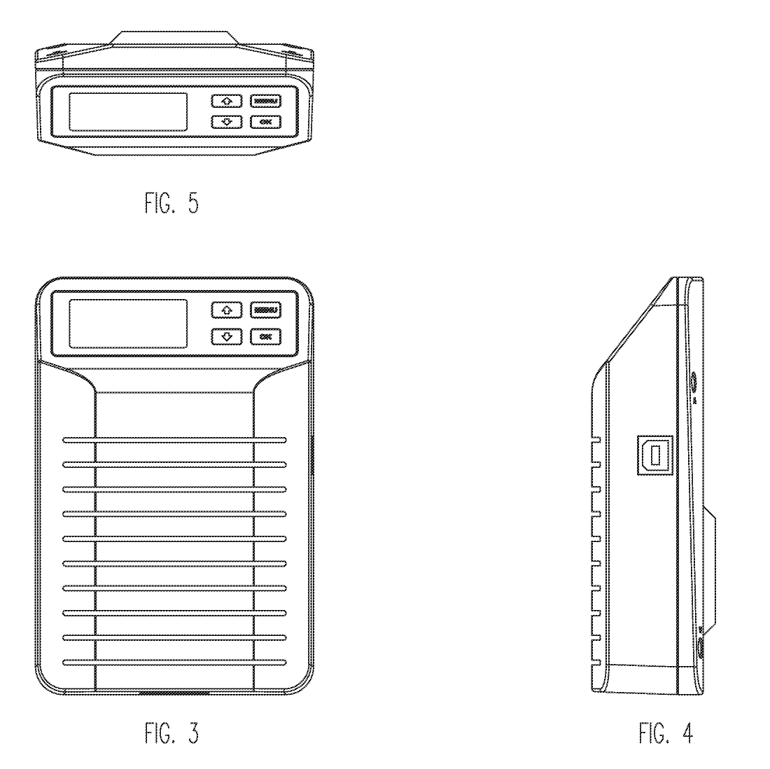

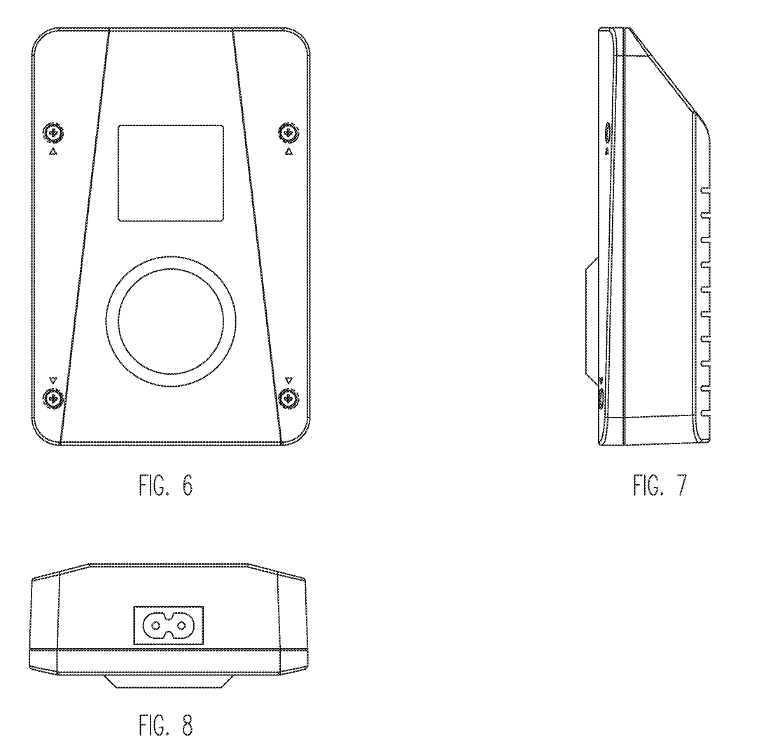

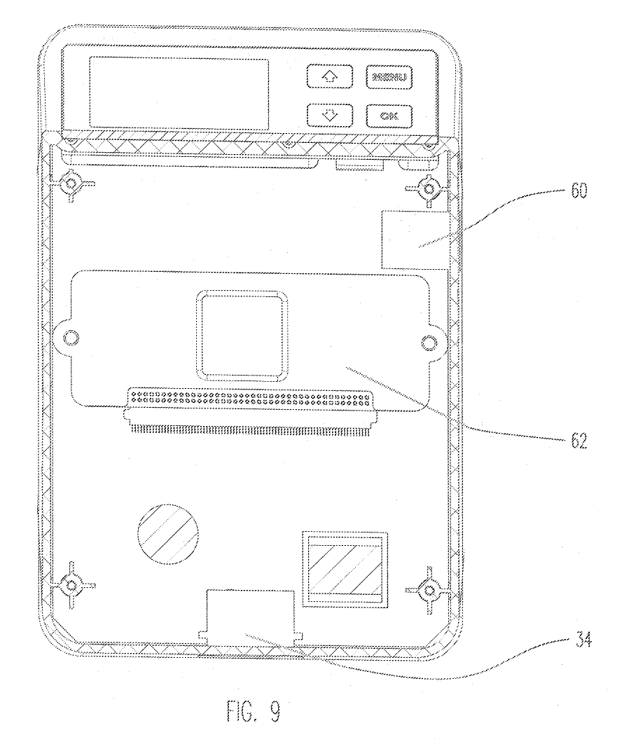

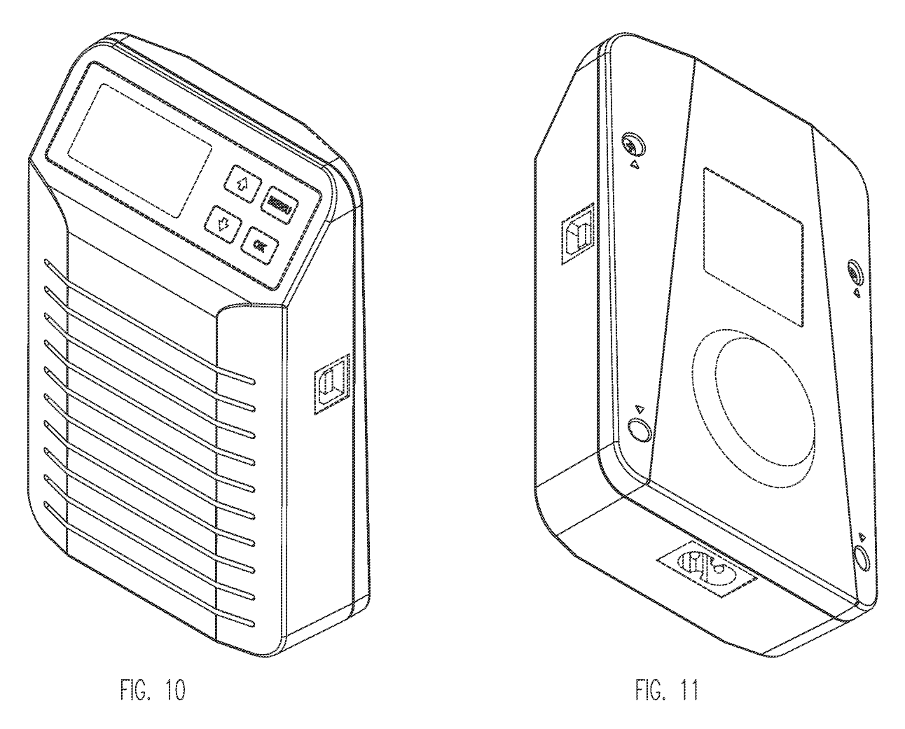

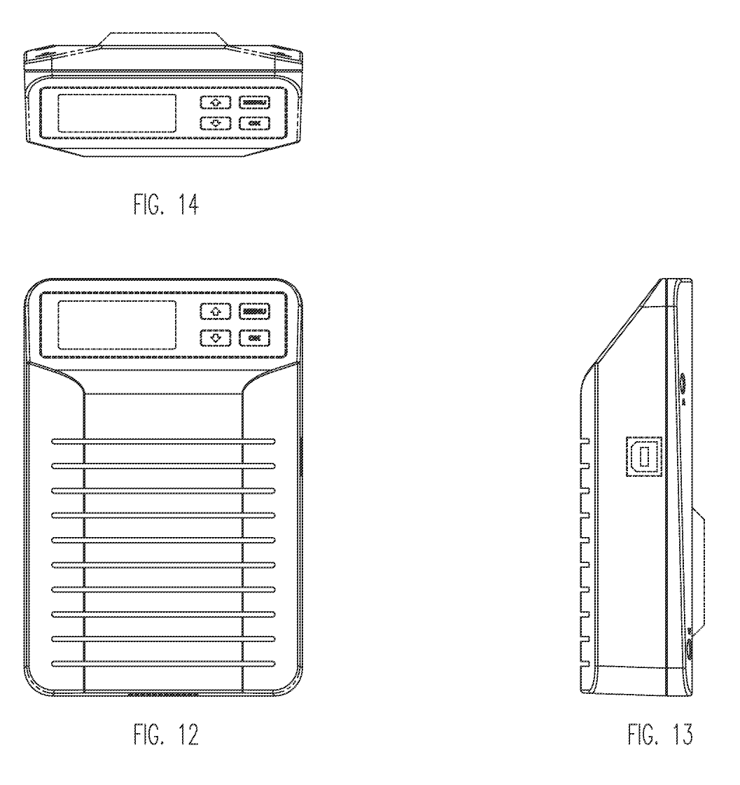

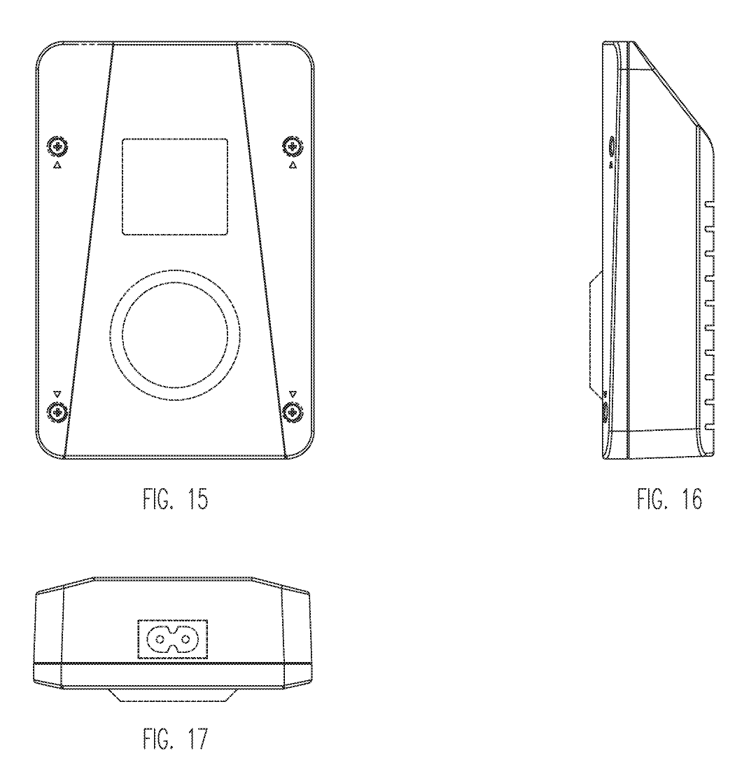

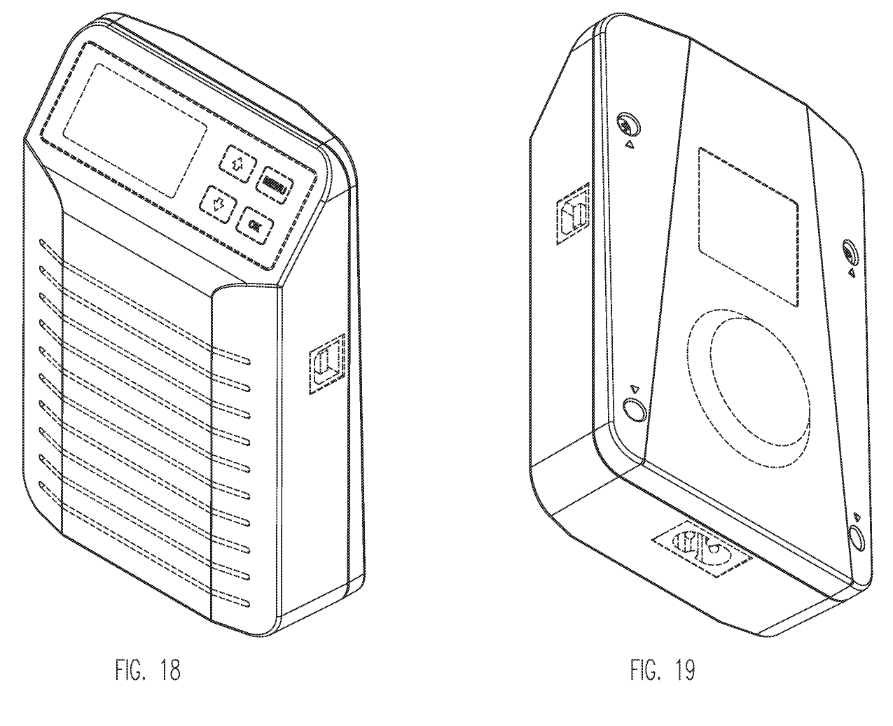

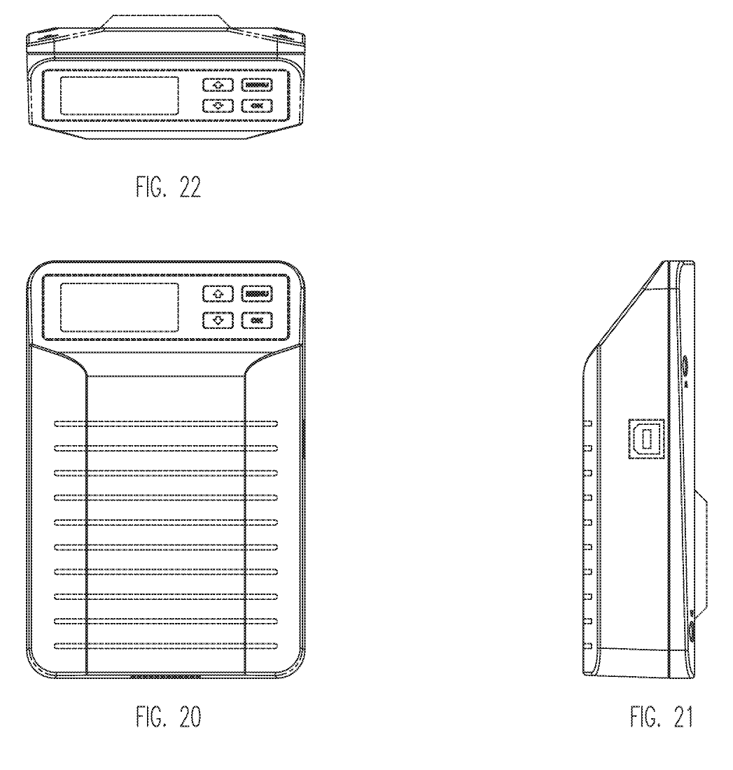

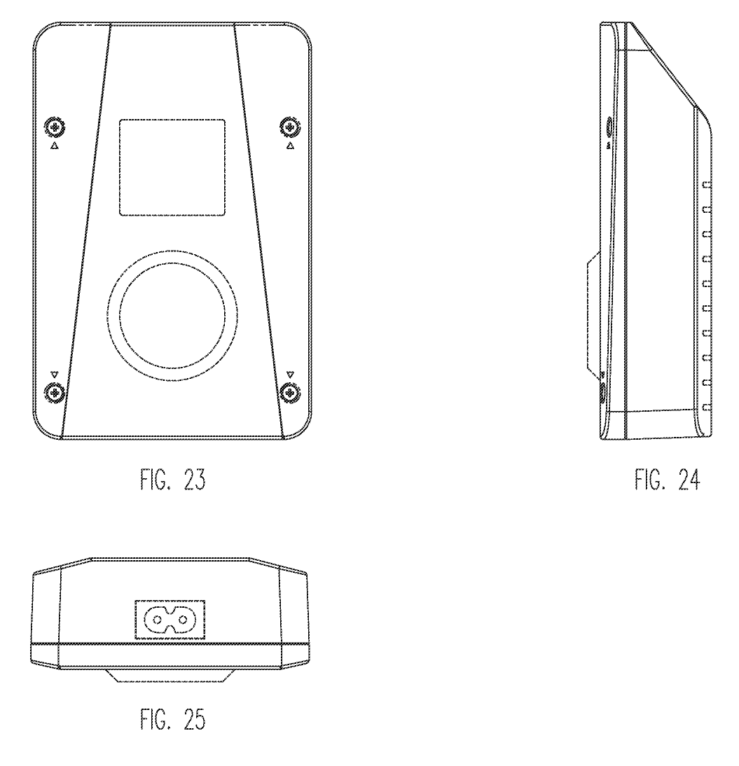

FIGS. 3-8, 10-17 and 18-25 show the ornamental features of various embodiments of the testing device.

I/we claim:

1. A device for testing and qualifying the quality, capacity and integrity of a new or existing mains power wiring system to transmit powerline communications (PLC) audio and control signals, including:
A) a hub testing device that emulates a PLC interface device of a PLC audio transmission source, including
a plug for insertion into an outlet of an AC mains wiring system,
a means for generating a digital audio signal,
a means for generating one or more testing signal selected from a control signal, a management signal, an interrogation signal, and a time data signal,
a means for distributing an encoded digital audio data signal including the digital audio signal and the testing signal into and throughout the mains electrical line system to a zone testing device; and
B) a zone testing device that emulates a zone audio amplifier module, including
a plug for insertion into an outlet of an AC mains wiring system,
a means for separating the encoded digital audio data signal from the AC power current of the AC mains wiring system,
a means for extracting audio data signals and control signals from the encoded digital audio data signals,
a means for generating one or more of a result signal selected from a control signal, a management signal, an interrogation, and a time data signal, and
a transmitter for transmitting the result signal through the AC mains wiring system to the hub testing device.

2. A method for testing and qualifying the quality, capacity and integrity of a new or existing mains power wiring system to transmit powerline communications (PLC) audio and control signals, comprising the steps of:
a) selecting a hub outlet proximate to the location of an audio transmission source;
b) plugging a hub testing device into the hub outlet;
c) initiating a search for a zone testing device;
d) plugging in a zone testing device into an first test outlet in a target zone;
e) optionally identifying the first test outlet via a user interface on the zone testing device;
f) initiating a test selected from a CQM test and a Streaming Analysis;
g) correlating the results of the test to determine if the selected hub outlet and the first test outlet qualify to transmit powerline communications (PLC) audio and control signals; and
h) optionally downloading a test log.
